(19) United States
(12) Patent Application Publication
(10) Pub. No.: US 2013/0194721 A1
(43) Pub. Date: Aug. 1, 2013

(54) ACTIVATED CARBON FOR LITHIUM ION CAPACITOR, ELECTRODE INCLUDING THE ACTIVATED CARBON AS ACTIVE MATERIAL, AND LITHIUM ION CAPACITOR USING THE ELECTRODE

(71) Applicant: SAMSUNG ELECTRO-MECHANICS CO., LTD., Suwon (KR)

(72) Inventors: Ji Sung CHO, Suwon (KR); Sang Kyun LEE, Suwon (KR); Bae Kyun KIM, Seongnam (KR); Hyun Chul JUNG, Yongin (KR)

(73) Assignee: SAMSUNG ELECTRO-MECHANICS CO., LTD., Suwon (KR)

(21) Appl. No.: 13/743,940

(22) Filed: Jan. 17, 2013

(30) Foreign Application Priority Data
Jan. 26, 2012 (KR) 10-2012-0007465

(51) Int. Cl. H01G 9/042; H01G 9/04; H01G 9/00

(52) U.S. Cl. CPC H01G 9/0425; H01G 9/155; H01G 9/058
USPC 361/502

(57) ABSTRACT

Disclosed herein are an activated carbon for a lithium ion capacitor, including mesopores with a pore size of 2˜50 nm in a content of 20˜30% based on all pores therein, an electrode including the activated carbon as an active material, and a lithium ion capacitor using the electrode. Accordingly, there can be provided an activated carbon having appropriate mesopores for allowing an increase in capacitance by free adsorption and desorption of the lithium ions, and a lithium ion capacitor storage device having a long lifespan and high input and output characteristics and further having reliability on high-rate charging and discharging cycles by including the activated carbon as an active material.

### CROSS REFERENCE(S) TO RELATED APPLICATIONS

This application claims the benefit under 35 U.S.C. Section 119 of Korean Patent Application Serial No. 10-2012-0007465, entitled “Activated Carbon for Lithium Ion Capacitor, Electrode Including the Activated Carbon as Active Material, and Lithium Ion Capacitor Using the Electrode” filed on Jan. 26, 2012, which is hereby incorporated by reference in its entirety into this application.

### BACKGROUND OF THE INVENTION

1. Technical Field

The present invention relates to an activated carbon for a lithium ion capacitor, an electrode including the activated carbon as an active material, and a lithium ion capacitor using the electrode.

2. Description of the Related Art

An electric double layer capacitor has excellent input and output characteristics and higher cycle reliability as compared with a lithium secondary battery, and thus a field of the electric double layer is under active development. As for main applicable examples of the electric double layer, it is promising as main power or auxiliary power for electric cars or a power storage device of renewable energy, such as solar power generation, wind power generation, or the like. In addition, the electric double layer is anticipated to be utilized as a device capable of outputting high current in a short time even in an interrupted power supply that is increasingly demanded by IT.

According to this electric double layer capacitor, one or plural pairs of polarizable electrodes (cathode, anode) mainly made of a carbon material face each other with a separator therebetween within an electrolytic liquid. Charges are stored on electric double layers formed at an interface between the polarizable electrodes and the electrolytic liquid.

Meanwhile, there are supposed so called a new lithium ion capacitor (LIC) storage device having an asymmetric type, such as a capacitor for improving energy density and using an electrolytic liquid including lithium ions in the electrolytic liquid. In this lithium ion capacitor storage device including the lithium ions, a cathode is different from an anode in view of materials or functions, and thus, an activated carbon is used for a cathode active material and a carbon material for facilitating reversible adsorption or desorption of lithium ions is used for an anode active material. In addition, the cathode and the anode are immersed in an electrolytic liquid containing lithium salt while a separate is inserted therebetween. The lithium ion capacitor storage device is used while the lithium ions are previously adsorbed on the anode.

A capacitance of the lithium ion capacitor storage device including the lithium ions results from the principle that negative ions in the electrolytic liquid are adsorbed on the cathode and lithium ions in the electrolytic liquid are adsorbed on the anode at the time of charging and negative ions are desorbed from the cathode and the lithium ions adsorbed on the anode are desorbed at the time of discharging.

In the lithium ion capacitor storage device including these lithium ions, the lithium ions are adsorbed (pre-doped) on the anode, and the potential of the anode is maintained lower than the potential of the electrolytic liquid. For this reason, the lithium ion capacitor storage device has an improved withstand voltage and improved capacitance itself as compared with the general electric double layer capacitor, thereby obtaining large energy density.

In addition, deep charging is impossible until the potential of the cathode reaches below a potential of the electrolytic liquid, and higher energy density may be realized in order to widen the using voltage. Meanwhile, in the lithium ion capacitor storage device as above, PF6⁻ is adsorbed to and desorbed from the cathode in the range of 3.0V˜3.8V and the lithium ion adsorbed to and desorbed from the cathode in the range of 3.0V˜2.2V. The lithium ion itself has a small diameter of 0.07 nm. However, the lithium ion does not exist in the electrolytic liquid alone but in a solvated form. Therefore, the solvated lithium ion has a size of about 4 nm.

In the case of the lithium ion capacitor storage device, the lithium ions are adsorbed to and desorbed from the anode at the time of charging and discharging, respectively, thereby realizing capacitance thereof. Hence, it is necessary to use an active material having a pore through which the solvated lithium ions can be easily adsorbed to and desorbed from the anode.

### SUMMARY OF THE INVENTION

An object of the present invention is to provide an activated carbon for a lithium ion capacitor having excellent capacitance and high-rate charging and discharging cycle reliability, by smooth adsorption and desorption of the solvated lithium ions.

Another object of the present invention is to provide an electrode including the activated carbon as an electrode active material, and a lithium ion capacitor using the same.

According to an exemplary embodiment of the present invention, there is provided an activated carbon for a lithium ion capacitor, the activated carbon including mesopores with a pore size of 2˜50 nm in a content of 20˜30% based on all pores therein.

The activated carbon may have a specific surface area of 1500˜2100m²/g.

The activated carbon may have an average particle size (D50) of 5˜10μm.

The activated carbon may have at least one impurity selected from the group consisting of K, Ca, Fe, Cr, and Ni, and a content of the impurity may be 50 ppm or less.

The activated carbon may have an oxygen (O₂) content of 0.3 ppm or less.

The activated carbon may be obtained by subjecting a shell of palm as a source to steam activation at a carbonizing temperature of 800˜1000° C.

According to another exemplary embodiment of the present invention, there is provided an electrode including the activated carbon as an electrode active material.

According to still another exemplary embodiment of the present invention, there is provided a lithium ion capacitor using the electrode.

The electrode may be a cathode.

The lithium ion capacitor may use an anode including a carbon material allowing reversible adsorption and desorption of lithium ions as an active material.

The anode may be pre-doped with the lithium ions.

### DESCRIPTION OF THE PREFERRED EMBODIMENTS

Hereinafter, the present invention will be described in more detail.

Terms used in the present specification are for explaining the embodiments rather than limiting the present invention. Unless explicitly described to the contrary, a singular form includes a plural form in the present specification. Also, used herein, the word “comprise” and/or “comprising” will be understood to imply the inclusion of stated constituents, steps, operations and/or elements but not the exclusion of any other constituents, steps, operations and/or elements.

The present invention relates to a lithium ion capacitor having reduced capacitance by using an activated carbon having a controlled pore size, that is to say, having many mesopores, and having increased capacitance by facilitating insertion and emission of lithium ions.

Firstly, the activated carbon for a lithium ion capacitor according to the present invention is characterized by including mesopores having a pore size of 2˜50 nm in a content of 20˜30% of the total pores therein. In the lithium ion capacitor (LIC) storage device, in the case of an activated carbon having many mesopores having the above pore size, lithium ions easily enter or leave the activated carbon and small resistance is achieved.

Since an activated carbon used as a general active material has no SEI films such as graphite, the lithium ions are solvated when they are adsorbed on the activated carbon in the range of 3.0V˜2.2V. Since the solvated lithium ion has a size of about 4nm, the activated carbon of the present invention may include mesopores having a pore size of about 2˜50nm in 20˜30% therein, so that the solvated lithium ions are easily adsorbed into or desorbed from pores of the activated carbon.

If the mesopores of the activated carbon is below 20%, adsorption and desorption of the lithium ions are not easy, and thus, movement resistance of the lithium ions may be increased and cell resistance also may be increased. If above 30%, packing density of the activated carbon may be deteriorated, resulting in undesirable results.

In addition, the activated carbon according to the present invention preferably has a specific surface area of 1500˜2100m²/g. If the specific surface area thereof is out of the above range, it is difficult to control mixing of the powder and regulate packing density, resulting in undesirable results.

In addition, the activated carbon according to the present invention preferably has an average particle size (D50) of 5˜10 μm. If the average particle size thereof is below 5 μm, there may be problems in uniform mixing due to particle atomization. If above 10 μm, a uniform electrode layer may be formed at the time of coating active material slurry.

In addition, the activated carbon according to the present invention contains at least one impurity selected from the group consisting of K, Ca, Fe, Cr, and Ni, and the content thereof is 50 ppm or less, and preferably 30 ppm or less. If the content of impurity is above 50 ppm, degradation in reliability may be caused by the sub-reaction, resulting in undesirable results.

In addition, the activated carbon has a content of oxygen (O₂) of 0.3 ppm or less, and preferably 0.1 ppm or less. If the content of oxygen (O₂) is above 0.3 ppm, degradation in reliability may be caused by deterioration of the activated carbon.

A material for the activated carbon according to the present invention is not particularly limited, but specifically the shell of palm is preferably used. In addition, the activated carbon is preferably prepared by steam activation at a carbonization temperature of 800˜1000° C.

This is for facilitating adsorption and desorption of the lithium ions by properly regulating the size of pores inside the activated carbon. In the case of an active material subjected to alkali-activation, 90% or more of pores consist of micropores having a pore size of smaller than 2 nm, and thus, it is difficult to attain the effects of the present invention. That is to say, since micropores with a size of smaller than 2 nm are mainly developed in the activated carbon subjected to alkali activation, the solvated lithium ions of about 4 nm can not enter them, and thus, it is advantageous to use an activated carbon activated with steam.

In addition, the present invention provides a lithium ion capacitor including a cathode containing the activated carbon having the above structural characteristic as an active material, an anode, and an electrolytic liquid.

The cathode may be prepared by coating active material slurry containing the activated carbon having 20˜30% of mesopores according to the present invention therein, a binder, a solvent, and other additives, on the cathode current collector, or molding the activated carbon to be in a sheet type by using a binder and then adhering it onto the current collector by using a conductive adhesive. In addition, the cathode may contain electrically conductive carbon black or graphite in order to lower resistance.

A material conventionally used in the electric double-layer capacitor or lithium ion battery may be used for a cathode current collector. Examples of the material may include at least one selected from the group consisting of aluminum, stainless, titanium, tantalum, and niobium. Among them, aluminum is preferable. In addition, the current collector preferably has a thickness of 10˜300 μm. An example of the above current collector may include a metal foil, an etched metal foil, or those having holes penetrating through front and rear surfaces thereof, such as an expanded metal, a punching metal, a net, foam, or the like.

The anode of the present invention can be prepared by coating active material slurry containing an active material, a binder, a conductive material, a solvent, and other additives on an anode current collector.

Any carbon material that can allow reversible adsorption and desorption of the lithium ions may be used as the anode active material. Examples of the active material may include natural graphite, artificial graphite, graphitized mesophase carbon microbeads (MCMB), graphitized mesophase carbon fiber (MCF), graphite whiskers, graphitized carbon fibers, non-graphitizing carbon, polyacene-based organic semiconductors, carbon nanotubes, a carbon composite material of a carbonaceous material and a graphitic material, a pyrolysis material of condensed polycyclic hydrocarbon, such as, a pyrolysis material of furfuryl alcohol resin, a pyrolysis material of Novolac resin, pitch, coke, and the other. These may be used alone or in combination.

The anode active material has preferably a specific surface area of 1˜1000 m²/g, measured by a BET method. Among the above carbon materials, graphitized mesophase carbon microbeads (MCMB), graphitized mesophase carbon fiber (MCF), and non-graphitizing carbon are more preferable.

In addition, a material used in the conventional electric double-layer capacitor or lithium ion battery may be used for an anode current collector. Examples of the material may be stainless steel, copper, nickel, or an alloy thereof, and copper is preferable among them. The anode current collector preferably has a thickness of about 10˜300 μm. Examples of the above current collector may include the metal foil, an etched metal foil, or those having holes penetrating through front and rear surfaces thereof, such as an expanded metal, a punching metal, a net, foam, or the like.

In addition, one that is pre-doped with lithium ions is preferably used as the anode, and a method for pre-doping is not particularly limited.

A binder (binding agent) may not be contained in the cathode and anode, and for example, they may be formed in a plate type or sheet type. However, the cathode and anode may be molded by using a binder as a shaping agent together with the active material. Examples of the usable binder may include a fluorine-based resin such as polytetrafluoroethylene (PTFE), polyvinylidene fluoride (PVdF), or the like; a thermoplastic resin such as polyimide, polyamideimide, polyethylene (PE), polypropylene (PP), or the like; a cellulose-base resin such as carboxymethylcellulose (CMC) or the like; or a rubber-based resin such as styrene-butadiene or the like. Among them, the fluorine-based resin is preferable in view of heat resistance and chemical stability. In particular, PTFE is preferable for the cathode and PVdF is preferable for the anode, since they are used to facilitate the manufacture of electrodes having excellent liquid absorbing property.

A non-aqueous organic electrolytic liquid in which a lithium salt is dissolved is preferable as the electrolytic liquid according to the present invention. As an organic solvent to be used, an aprotic organic solvent is preferable. The organic solvent is appropriately selected according to solubility, reactivity with electrode, viscosity, and use temperature range of the electrolytic liquid. Specific examples of this organic solvent may include at least one selected from a group consisting of propylene carbonate (PC), diethyl carbonate, ethylene carbonate (EC), sulfolane, acetone nitrile, dimethoxy ethane and tetrahydrofuran, and ethyl methyl carbonate (EMC), but is not limited thereto. Among the organic solvents, a mixed solvent of EC and EMC is preferable, and the blending ratio therebetween is preferable about 1:1˜1:2, but is not limited thereto.

The lithium ion capacitor according to the present invention has a structure where an electrode cell essentially consisting of the cathode and the anode insulated therebetween by the separator is impregnated with the electrolytic liquid, and then this is contained in an external case.

Hereinafter, examples of the present invention will be described in detail. The following examples merely illustrate the present invention, but the scope of the present invention should not be construed to be limited by these examples. Further, the following examples are illustrated by using specific compounds, but it is apparent to those skilled in the art that equivalents thereof are used to obtain equal or similar levels of effects.

### Example 1

1) Preparation of Cathode

A shell of palm was subjected to steam activation at 800° C. to prepare an activated carbon containing 25% of mesopores with a pore size of 2˜50 nm.

The prepared activated carbon had a specific surface area of 1900 m²/g, an average particle size (D50) of 10 μm, a content of impurities (Fe, Ca, and Cr) of 50 ppm, and a content of oxygen (O₂) of 0.3 ppm.

The activated carbon powder subjected to steam activation, acetylene black, and PVDF were mixed at a weight ratio of 80:10:10, and the mixture was mixed with and stirred with NMP which is a solvent, to obtain a cathode active material slurry. The slurry was coated on an aluminum foil with a thickness of 20 μm by a doctor blade method, followed by preliminary drying, and then the resultant structure was cut to an electrode size of 5 mm×12.5 mm. The electrode had a thickness of about 50 μm. The electrode was dried in the vacuum at 120° C. for 10 hours before cell assembling.

2) Preparation of Anode

Commercial graphite was used to prepare an anode by using an active material. The graphite, acetylene black, and PVDF were mixed at a weight ratio of 80:10:10, and the mixture was mixed with and stirred with NMP which is a solvent, to obtain an anode active material slurry.

The slurry was coated on a copper foil with a thickness of 10 μm by a doctor blade method, followed by preliminary drying, and then the resultant structure was cut to an electrode size of 5 mm×12.5 mm. The electrode had a thickness of about 20 μm. The electrode was dried in the vacuum at 120° C. for 5 hours before cell assembling.

3) Preparation of Electrolytic Liquid

An electrolytic liquid was prepared by dissolving LiPF₆ in EC:PC:EMC (3:1:2 (wt %)) to have a concentration of 1.2 mol/L.

4) Lithium Pre-Doping of Anode and Cell Assembling.

The anode was previously doped with lithium ions by contacting a lithium metal copper foil and the anode with each other for 2 hours. A dope amount of lithium was about 75% capacitance of the anode.

A lithium ion capacitor cell where a separator (PP) was inserted between the cathode prepared in 1) and the pre-doped anode was sealed in a laminated case.

The thus completed cell was left intact for about one day before measurement of physical properties. For electrochemical assessment, the laminate cell was put between two structure-supporting plates and fixed by clips.

### Comparative Example 1

A lithium ion capacitor cell was manufactured by the same procedure as Example 1, except that oil pitch was used as a material for a cathode active material and activated carbon subjected to alkali activation in an aqueous KOH solution at 900° C. was used.

The activated carbon subjected to alkali activation had 5% of mesopores with a pore size of 2˜50 nm, 95% of micropores with a pore size of smaller than 2 nm, and a specific surface area of 2200 m²/g and an average particle size (D50) of 10 μm.

### Experimental Example: Assessment on Capacitance of Lithium Ion Capacitor Cell

As for the lithium ion capacitor cells according to Example 1 and Comparative Example 1, capacitance at 4.0V˜3.0V (cathode) and capacitance at 3.0V˜2.0V (anode) were respectively measured at 10 C. A capacitance ratio therebetween was calculated as follows, and the results were tabulated in Table 1.

Capacitance ratio between oxidation region and reduction region=cathode capacitance (4V˜3V)/ cathode capacitance (3V˜2V)

Cathode capacitance (4V˜3V): Capacitance of cathode part realized by PF₆⁻ negative ion

Cathode capacitance (3V˜2V): Capacitance of cathode part realized by Li+ positive ion

Results mean that as the lower the capacitance ratio between oxidation region and reduction region, the higher the capacitance at the cathode due to the contribution of lithium ion.

TABLE 1

| | Capacitance ratio between oxidation region |
|---|---|
| | and reduction region |
| Comparative | 1.4 |
| Example 1 | |
| Example 1 | 1.2 |

As shown in results of Table 1, it can be seen that capacitance due to the contribution of lithium ion is higher in the lithium ion capacitor according to Example 1 including the activated carbon subjected to steam activation and containing 25% of mesopores with a pore size of 2˜50 nm therein than in the lithium ion capacitor including the activated carbon according to Comparative Example 1 mainly containing micropores.

Therefore, a lithium ion capacitor storage device having long lifespan and high input and output characteristics, and further excellent reliability on high-rate charging and discharging cycle can be provided by using the electrode including the activated carbon as an active material.

According to the present invention, there can be provided an activated carbon having appropriate mesopores for allowing an increase in capacitance by free adsorption and desorption of the lithium ions, and a lithium ion capacitor storage device having a long lifespan and high input and output characteristics and further having reliability on high-rate charging and discharging cycles by using the activated carbon as an active material.

What is claimed is:

1. An activated carbon for a lithium ion capacitor, the activated carbon comprising mesopores with a pore size of 2˜50nm in a content of 20˜30% based on all pores therein.

2. The activated carbon according to claim 1, wherein it has a specific surface area of 1500˜2100 m²/g.

3. The activated carbon according to claim 1, wherein it has an average particle size (D50) of 5˜10 μm.

4. The activated carbon according to claim 1, wherein it has at least one impurity selected from the group consisting of K, Ca, Fe, Cr, and Ni, and a content of the impurity is 50 ppm or less.

5. The activated carbon according to claim 1, wherein it has an oxygen (O₂) content of 0.3 ppm or less.

6. The activated carbon according to claim 1, wherein it is obtained by subjecting a shell of palm as a source to steam activation at a carbonizing temperature of 800˜1000° C.

7. An electrode comprising the activated carbon according to claim 1 as an electrode active material.

8. A lithium ion capacitor using the electrode according to claim 7.

9. The lithium ion capacitor according to claim 8, wherein the electrode is a cathode.

10. The lithium ion capacitor according to claim 8, wherein it uses an anode including a carbon material allowing reversible adsorption and desorption of lithium ions as an active material.

11. The lithium ion capacitor according to claim 10, wherein the anode is pre-doped with the lithium ions.
